(19) United States
(12) Patent Application Publication
(10) Pub. No.: US 2018/0233144 A1
(43) Pub. Date: Aug. 16, 2018

(54) VOICE INPUT METHOD AND APPARATUS

(71) Applicant: BEIJING BAIDU NETCOM SCIENCE AND TECHNOLOGY CO., LTD., Beijing (CN)

(72) Inventor: Xiaojun YUAN, Beijing (CN)

(21) Appl. No.: 15/724,986

(22) Filed: Oct. 4, 2017

(30) Foreign Application Priority Data
Feb. 16, 2017 (CN) 201710083638.X

(51) Int. Cl. G10L 15/22; G10L 15/26; G10L 21/12; G06F 3/16; G10L 15/30

(52) U.S. Cl. CPC G10L 15/22; G10L 15/26; G10L 15/30; G06F 3/165; G06F 3/167; G10L 21/12

(57) ABSTRACT

The present disclosure discloses a voice input method and apparatus. A specific embodiment of the method includes: switching, in response to detecting an instruction to start a voice input mode, a current input mode of an input method application to the voice input mode; recognizing a volume value of a voice input by a user in the voice input mode; determining whether the recognized volume value is within a preset volume value range; presenting to the user prompt information for prompting the user to control the volume value of the currently input voice, if the recognized volume value is not within the preset volume value range; and outputting, in response to receiving an instruction to end the voice input, the voice input by the user in the voice input mode in a preset mode.

### CROSS-REFERENCE TO RELATED APPLICATION

This application claims the priority of Chinese Patent Application No. 201710083638.X, entitled “Voice Input Method and Apparatus” filed on Feb. 16, 2017, the content of which is incorporated herein by reference in its entirety.

### TECHNICAL FIELD

The present disclosure relates to the field of computer technology, specifically to the field of input method technology, and more specifically to a voice input method and apparatus.

### BACKGROUND

An input application is a software to achieve text or voice input. The existing input method application may include a plurality of input modes, such as the Pinyin input mode, the Five-stroke input mode, the handwriting input mode and the voice input mode. Among them, the voice input mode may be considered as the currently most simplistic and easy to use input mode in the world. As long as the user speaks, a fast and convenient voice input can be achieved.

However, when the user adopts the voice input mode for inputting voice, if the voice volume input by the user is high, it will cause interference to the surrounding environment.

### SUMMARY

The objective of the present disclosure is to provide an improved voice input method and apparatus, in order to solve the technical problem mentioned in the foregoing Background section.

In a first aspect, the present disclosure provides a voice input method, comprising: switching, in response to detecting an instruction to start a voice input mode, a current input mode of an input method application to the voice input mode; recognizing a volume value of a voice input by a user in the voice input mode; determining whether the recognized volume value is within a preset volume value range; presenting to the user prompt information for prompting the user to control the volume value of the currently input voice, if the recognized volume value is not within the preset volume value range; and outputting, in response to receiving an instruction to end the voice input, the voice input by the user in the voice input mode in a preset mode.

In some embodiments, the determining whether the recognized volume value is within a preset volume value range comprises: generating a waveform matching the recognized volume value based on the recognized volume value, and displaying the waveform in an input area of the input method application; and determining whether an amplitude of the waveform exceeds a target area, wherein the target area is an area pre-partitioned in the input area matching the preset volume value range.

In some embodiments, the presenting to the user prompt information for prompting the user to control the volume value of the currently input voice, if the recognized volume value is not within the preset volume value range, comprises: presenting to the user prompt information for prompting the user to reduce the volume value of the input voice, if a crest of the waveform crosses an upper limit indication line of the target area, wherein the upper limit indication line corresponds to a maximum value of the preset volume value range.

In some embodiments, the presenting to the user prompt information for prompting the user to control the volume value of the currently input voice, if the recognized volume value is not within the preset volume value range, comprises: presenting to the user a prompt for prompting the user to increase the volume value of the input voice, if a trough of the waveform crosses a lower limit indication line of the target area, wherein the lower limit indication line corresponds to a minimum value of the preset volume value range.

In some embodiments, the outputting, the voice input by the user in the voice input mode in a preset mode comprises: outputting a text matching the voice input by the user, the text being converted from the voice input by the user in the voice input mode.

In some embodiments, the outputting, the voice input by the user in the voice input mode in a preset mode comprises: amplifying the voice input by the user in the voice input mode and outputting the amplified voice.

In some embodiments, a prompting mode of the prompt includes at least one of the following: a vibration prompt, a ringtone prompt, a voice prompt and a text prompt.

In a second aspect, the present disclosure provides a voice input apparatus, comprising: a switching unit, configured to switch, in response to detecting an instruction to start a voice input mode, a current input mode of an input method application to the voice input mode; a recognizing unit, configured to recognize a volume value of a voice input by a user in the voice input mode; a determining unit, configured to determine whether the recognized volume value is within a preset volume value range; a prompting unit, configured to present to the user prompt information for prompting the user to control the volume value of the currently input voice, if the recognized volume value is not within the preset volume value range; and an outputting unit, configured to output, in response to receiving an instruction to end the voice input, the voice input by the user in the voice input mode in a preset mode.

In some embodiments, the determining unit comprises: a generating subunit, configured to generate a waveform matching the recognized volume value based on the recognized volume value, and display the waveform in an input area of the input method application; and a determining subunit, configured to determine whether an amplitude of the waveform exceeds a target area, wherein the target area is an area pre-partitioned in the input area matching the preset volume value range.

In some embodiments, the prompting unit is further configured to: present to the user prompt information for prompting the user to reduce the volume value of the input voice, if a crest of the waveform crosses an upper limit indication line of the target area, wherein the upper limit indication line corresponds to a maximum value of the preset volume value range.

In some embodiments, the prompting unit is further configured to: present to the user prompt information for prompting the user to increase the volume value of the input voice, if a trough of the waveform crosses a lower limit indication line of the target area, wherein the lower limit indication line corresponds to a minimum value of the preset volume value range.

In some embodiments, the outputting unit is further configured to: output a text matching the voice input by the user, the text being converted from the voice input by the user in the voice input mode.

In some embodiments, the outputting unit is further configured to: amplify the voice input by the user in the voice input mode and output the amplified voice.

In some embodiments, a prompting mode of the prompt includes at least one of the following: a vibration prompt, a ringtone prompt, a voice prompt and a text prompt.

In a third aspect, the present disclosure provides a terminal device, comprising: one or more processors; a storage, to store one or more programs, when the one or more programs being executed by the one or more processors, cause the one or more processors to perform a voice input method of the first aspect.

In a fourth aspect, the present disclosure provides a computer readable storage medium storing a computer program thereon, the program, when executed by a processor, performs a voice input method of the first aspect.

By recognizing a volume value of a voice input by a user in the voice input mode, determining whether the recognized volume value is within a preset volume value range, then presenting to the user prompt information for prompting the user to control the volume value of the currently input voice if the recognized volume value is not within the preset volume value range, and finally outputting, in response to receiving an instruction to end the voice input, the voice input by the user in the voice input mode in a preset mode, the voice input method and apparatus provided by the present disclosure realizes the effective control to the volume value of the voice input by the user in the voice input mode, effectively reduces the occurrences of situations such as the interference to the surrounding environment, the incorrect or the unrecognisable voice recognition, when the user adopts the voice input mode for voice inputting.

### BRIEF DESCRIPTION OF THE DRAWINGS

After reading detailed descriptions of non-limiting embodiments with reference to the following accompanying drawings, other features, objectives and advantages of the present disclosure will be more apparent:

FIG. 1 is an exemplary system architecture diagram in which the present disclosure may be applied;

FIG. 2 is a flowchart of an embodiment of a voice input method according to the present disclosure;

FIG. 3a illustrates a schematic diagram of a voice input interface;

FIG. 3b illustrates a schematic diagram of presenting a text prompt on the voice input interface;

FIG. 3c illustrates a schematic diagram of presenting a text matching the voice on the voice input interface;

FIG. 4 is a flowchart of another embodiment of the voice input method according to the present disclosure;

FIG. 5 is a schematic structural diagram of an embodiment of a voice input apparatus according to the present disclosure; and

FIG. 6 is a schematic structural diagram of a computer system adapted to implement a terminal device of embodiments of the present disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant invention, rather than limiting the invention. In addition, it should be noted that, for the ease of description, only the parts related to the relevant invention are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

FIG. 1 shows an exemplary architecture of a system 100 which may be used by a method and apparatus for voice input according to an embodiment of the present application.

As shown in FIG. 1, the system architecture 100 may include terminal device 101, a network 102 and a server 103. The network 102 serves as a medium providing a communication link between the terminal device 101 and the server 103. The network 102 may include various types of connections, such as wired or wireless transmission links, or optical fibers.

The user 110 may use the terminal device 101 to interact with the server 103 through the network 102, in order to transmit or receive messages, etc. Various communication client applications, such as input method applications, search engine applications, instant messaging tools, social platform software, may be installed on the terminal device 101.

The terminal device 101 may be various electronic devices supporting voice input function, including but not limited to smart phones, tablet computers, laptop computers, desktop computers, etc. Specifically, the terminal device 101 may first recognize the volume value of a voice input by the user in the voice input mode, then present to the user prompt information for prompting the user to control the volume value of the currently input voice, if the recognized volume value is not within the preset volume value range, and finally send the voice input by the user in a preset mode to the server 103, in the case where an instruction to end the voice input sent by the user is received.

The server 103 may be a backend server for various client applications installed on the terminal device 101. The backend server may process, such as analyze the voice output in the preset mode received from the terminal device 101 and feed the processing result (e.g., a webpage corresponding to the voice output in the preset mode) back to the terminal device 101, or send the processing result (e.g., the voice output in the preset mode) to other terminal devices that communicates with the terminal device 101.

It should be noted that the voice input method provided by the embodiments of the present disclosure is generally executed by the terminal device 101, accordingly, the voice input apparatus is generally provided in the terminal device 101.

It should be appreciated that the numbers of the terminal devices, the networks and the servers in FIG. 1 are merely illustrative. Any number of terminal devices, networks and servers may be provided based on the actual requirements.

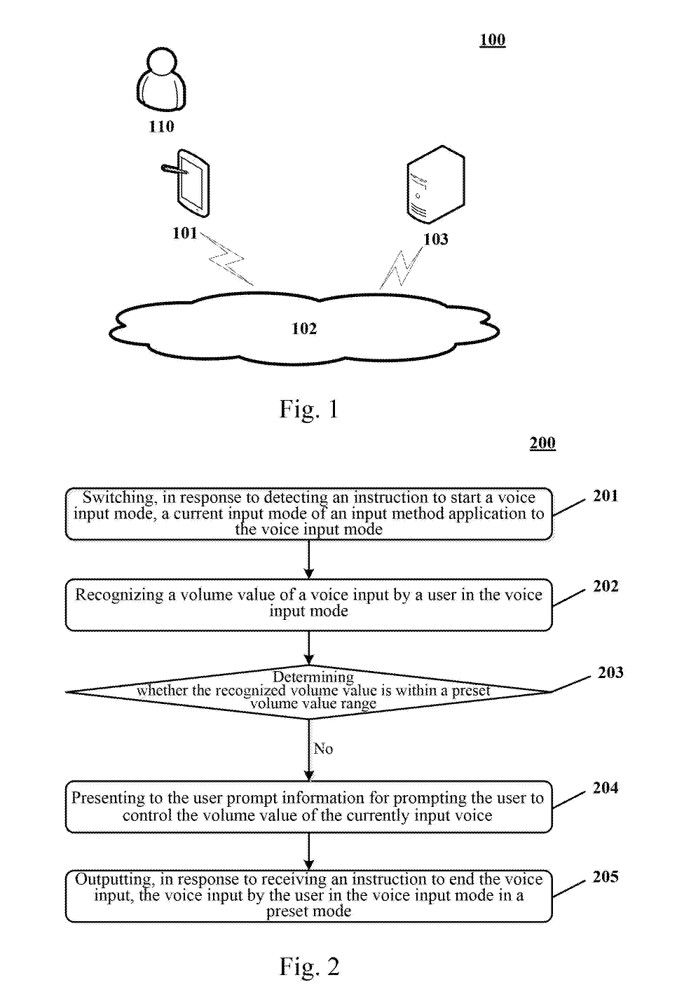

With further reference to FIG. 2, a flow 200 of an embodiment of the voice input method according to the present disclosure is illustrated. The voice input method includes the following steps:

Step 201, switching, in response to detecting an instruction to start a voice input mode, a current input mode of an input method application to the voice input mode.

In the present embodiment, an electronic device (e.g., the terminal device 101 as illustrated in FIG. 1) on which the voice input method operate may detect instructions input by the user to start various input modes, and switch the current input mode of the input method application to the voice input mode, in the case where an instruction to start the voice input mode is detected. Here, the input method application may include a plurality of input modes, for example, the Pinyin input mode, the Five-stroke input mode, the handwriting input mode, the voice input mode, etc.

Typically, a preset switching key may be set on the visual interface of the input method application. The user may operate the preset switching key, thus triggering the input method application to send the instruction to start the voice input mode to the voice input engine, in order to switching the current input mode of the input method to the voice input mode. Here, the preset switching key may include but is not limited to a physical switching key, a virtual switching key, etc.

It should be noted that the input method application may be an input method application that comes with the terminal device, also may be a third party input method application installed by the user on the terminal device. The present embodiment is not limited to a specific input method application.

Step 202, recognizing a volume value of a voice input by a user in the voice input mode.

In the present embodiment, the electronic device may recognize the volume value of the voice input by the user in the voice input mode, in the case where the current input mode of the input method application is the voice input mode.

Typically, a preset voice input key may be set on the visual interface of the input method application. The user may input voice while touching or pressing the preset voice input key, meanwhile the electronic device may recognize the volume value of the voice input by the user in real time. Here, the preset voice input key may include but is not limited to a physical voice input key, a virtual voice input key, etc.

In the present embodiment, the volume value of the voice may be represented in a plurality of ways, for example, the volume value of the voice may be represented by a decibel value.

Step 203, determining whether the recognized volume value is within a preset volume value range.

In the present embodiment, based on the volume value recognized in step 202, the electronic device may determine whether the recognized volume value is within the preset volume value range. For example, the electronic device may compare the recognized volume value with the maximum value and/or the minimum value of the preset volume value range. If the recognized volume value is greater than the maximum value of the preset volume value range and/or less than the minimum value of the preset volume value range, it is determined that the recognized volume value is not within the preset volume value range. Otherwise, it is determined that the recognized volume value is within the preset volume value range.

Typically, the preset volume value range may be set by default. For example, the preset volume value range may be set to between 25 and 40 dB in the case where the voice input by the user does not interfere with the surrounding environment and can be accurately recognized.

Step 204, presenting to the user prompt information for prompting the user to control the volume value of the currently input voice, if the recognized volume value is not within the preset volume value range.

In the present embodiment, if the recognized volume value is not within the preset volume value range, the electronic device may present prompt information to the user. Here, the prompt may be used to prompt the user to control the volume value of the currently input voice. For example, if the recognized volume value is greater than the maximum value of the preset volume value range, a prompt to reduce the volume value of the currently input voice is presented to the user. The user may properly reduce the volume of the currently input voice according to the prompt to ensure that the user does not interfere with the surrounding environment when inputting voice. If the recognized volume value is smaller than the minimum value of the preset volume value range, a prompt to increase the volume value of the currently input voice is presented to the user. The user may properly increase the volume of the currently input voice according to the prompt to ensure that the voice input by the user can be accurately recognized.

In some alternative implementations of the present embodiment, the prompting mode of the prompt may include but is not limited to at least one of the following: a vibration prompt, a ringtone prompt, a voice prompt and a text prompt. For example, the electronic device may present a text prompt to prompt the user to increase or reduce the volume value of the currently input voice on the visual interface of the input method application, when the recognized volume value is not within the preset volume value range.

Alternatively, in order to avoid the text prompt affecting the user's regular voice input, the text prompt may automatically disappear after displaying a preset time on the visual interface of the input method application. For example, the text prompt disappears automatically after displaying 1 s on the visual interface of the input method application.

Step 205, outputting, in response to receiving an instruction to end the voice input, the voice input by the user in the voice input mode in a preset mode.

In the present embodiment, the electronic device may output the voice input by the user in the voice input mode in the preset mode, in the case where the electronic device receives an instruction to end the voice input sent from the user. Generally, the electronic device may assume that the user has finished the present voice input, in the case where the user stops touching or pressing the preset voice input key.

In some alternative implementations of the present embodiment, the electronic device may output a text matching the voice input by the user converted from the voice input by the user in the voice input mode. For example, the electronic device may first perform a voice recognition to the voice input by the user to generate a text matching the voice input by the user, and then send the text matching the voice input by the user to the corresponding backend server.

In some alternative implementations of the present embodiment, the electronic device may output the voice input by the user in the voice input mode, after amplifying the volume of the voice. For example, the electronic device may first amplify the volume of the voice input by the user, and then send the amplified voice to the corresponding backend server, so that the corresponding backend server sends the amplified voice to other electronic devices that communicate with the electronic device.

In some alternative implementations of the present embodiment, the electronic device may directly output the voice input by the user in the voice input mode. For example, the electronic device may directly send the voice input by the user to the corresponding backend server, so that the corresponding backend server sends the voice to other electronic devices that communicate with the electronic device.

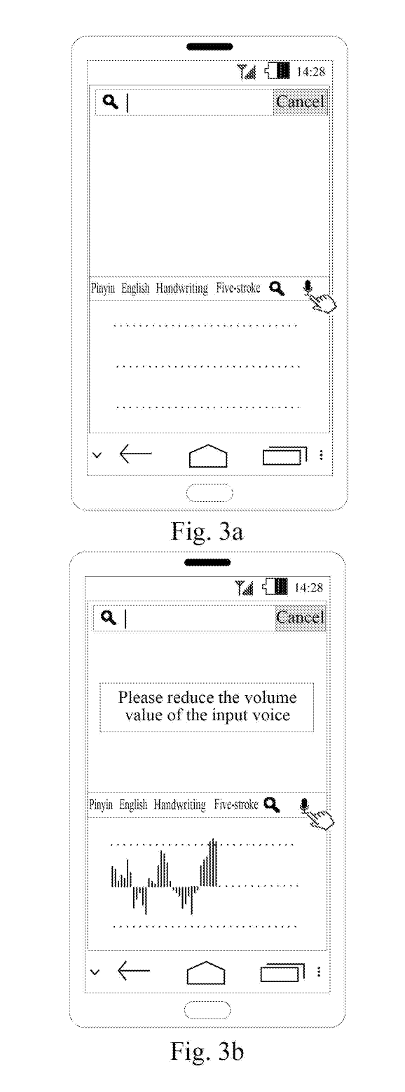

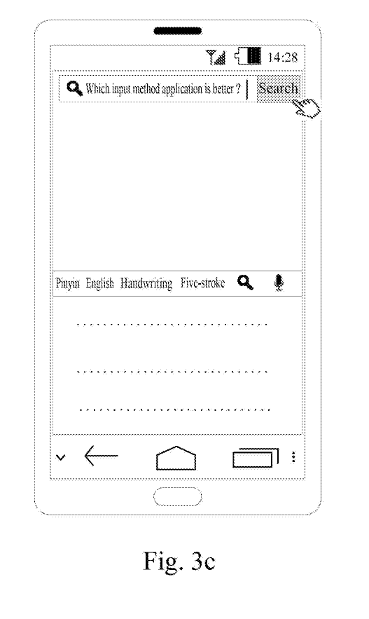

The present disclosure also provides an application scenario of the voice input method according to the present embodiment. First, the user initiates an instruction to start the voice input mode. The electronic device may switch the input mode of the input method application to the voice input mode. As shown in FIG. 3a, the voice input interface may be presented on the screen of the electronic device. Then, the electronic device may recognize the volume value of the voice input by the user in the voice input mode and determine whether the recognized volume value is within the preset volume value range. In the case where the recognized volume value is greater than the maximum value of the preset volume value range, as shown in FIG. 3b, a text prompt “please reduce the volume value of the input voice” may be presented on the voice input interface. Finally, in the case where the user sends an instruction to end the voice input, the electronic device may perform a voice recognition to the voice input by the user in the voice input mode to generate a text “which input method application is better?” matching the voice input by the user. As shown in FIG. 3c, the text “which input method application is better?” may be presented in the search box of the voice input interface, and the electronic device may also send the text “which input method application is better?” to the background server of the search engine application, in the case where the user clicks on the search key.

By recognizing the volume value of the voice input by the user in the voice input mode, determining whether the recognized volume value is within the preset volume value range, then presenting to the user prompt information for prompting the user to control the volume value of the currently input voice in the case where the recognized volume value is not within the preset volume value range, and finally outputting the voice input by the user in the voice input mode in the preset mode in the case where an instruction to end the voice input is received, the voice input method provided by the above embodiment of the present disclosure realizes the effective control to the volume value of the voice input by the user in the voice input mode, effectively reduces the occurrences of situations such as the interference to the surrounding environment, the incorrect or the unrecognisable voice recognition, when the user adopts the voice input mode for voice inputting.

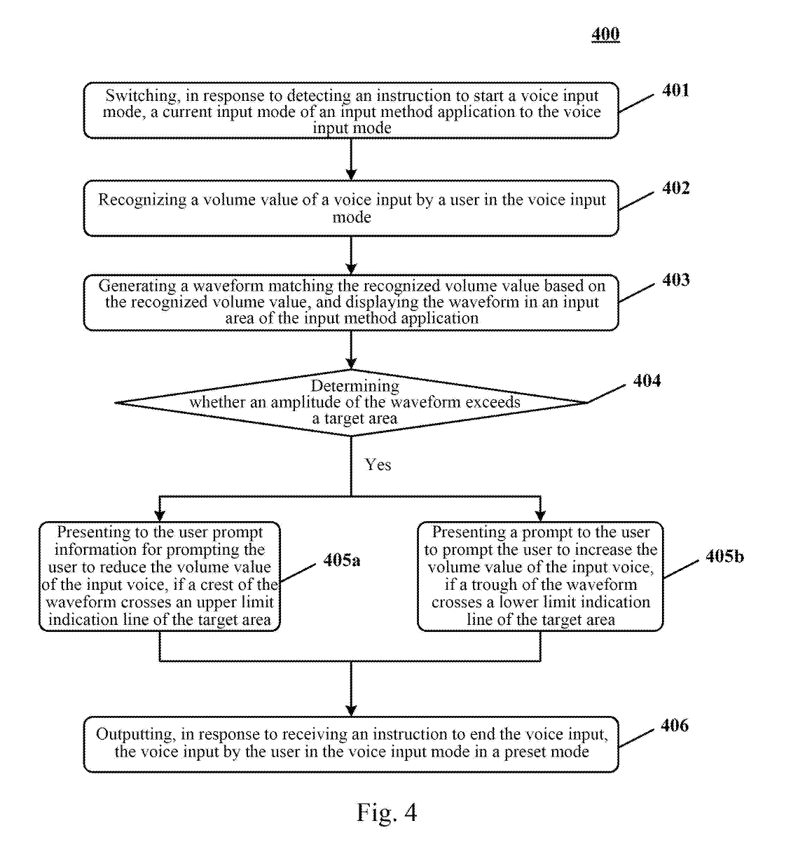

With further reference to FIG. 4, a flow 400 of another embodiment of the voice input method is illustrated. The flow 400 of the voice input method includes the following steps:

Step 401, switching, in response to detecting an instruction to start a voice input mode, a current input mode of an input method application to the voice input mode.

In the present embodiment, an electronic device (e.g., the terminal device 101 as illustrated in FIG. 1) on which the voice input method operate may detect instructions input by the user to start various input modes, and switch the current input mode of the input method application to the voice input mode, in the case where an instruction to start the voice input mode is detected.

Step 402, recognizing a volume value of a voice input by a user in the voice input mode.

In the present embodiment, the electronic device may recognize the volume value of the voice input by the user in the voice input mode, in the case where the current input mode of the input method application is the voice input mode.

Step 403, generating a waveform matching the recognized volume value based on the recognized volume value, and displaying the waveform in an input area of the input method application.

In the present embodiment, the electronic device may generate a waveform matching the recognized volume value, based on the volume value recognized in step 402, and display the waveform in the input area of the input method application. Generally, the abscissa of the waveform is time and the ordinate is the volume value.

Step 404, determining whether an amplitude of the waveform exceeds a target area.

In the present embodiment, the electronic device may determine whether the amplitude of the waveform exceeds the target area, based on the waveform matching the recognized volume value generated in step 403. Here, the amplitude of the waveform is the ordinate of each moment, and the target area is an area pre-partitioned in the input area matching the preset volume value range. Generally, the range of the target area is jointly defined by the upper limit indication line and the lower limit indication line of the target area. The upper limit indication line corresponds to the maximum value of the preset volume value range, and the lower limit indication line corresponds to the minimum value of the preset volume value range.

In the present embodiment, the electronic device may determine whether the amplitude of the waveform exceeds the target area. If the crest of the waveform crosses the upper limit indication line of the target area, step 405a is performed; if the trough of the waveform crosses the lower limit indication line of the target area, the 405b is performed. Here, the crest is the maximum value of the amplitude, and the trough is the minimum value of the amplitude.

Step 405a, presenting to the user prompt information for prompting the user to reduce the volume value of the input voice, if a crest of the waveform crosses an upper limit indication line of the target area.

In the present embodiment, based on the determined result of step 404, the electronic device may present prompt information for reducing the volume value of the currently input voice, in the case where the crest of the waveform crosses the upper limit indication line of the target area. The user may properly reduce the volume of the currently input voice according to the prompt to ensure that the user does not interfere with the surrounding environment when inputting voice. Here, the upper limit indication line corresponds to the maximum value of the preset volume value range.

Step 405b, presenting to the user prompt information for prompting the user to increase the volume value of the input voice, if a trough of the waveform crosses a lower limit indication line of the target area.

In the present embodiment, based on the determined result of step 404, the electronic device may present prompt information for increasing the volume value of the currently input voice, in the case where the trough of the waveform crosses the lower limit indication line of the target area. The user may properly increase the volume of the currently input voice according to the prompt to ensure that the voice input by the user can be accurately recognized. Here, the lower limit indication line corresponds to the minimum value of the preset volume value range.

Step 406, outputting, in response to receiving an instruction to end the voice input, the voice input by the user in the voice input mode in a preset mode.

In the present embodiment, the electronic device may output the voice input by the user in the voice input mode in the preset mode, in the case where the electronic device receives an instruction to end the voice input sent by the user.

As can be seen from FIG. 4, the flow 400 of the voice input method in the present embodiment, as compared with the corresponding embodiment in FIG. 2, highlights the step of determining whether the recognized volume value is within the preset volume value range based on whether the amplitude of the waveform corresponding to the recognized volume value exceeds the target area. Thus, the solution described in the present embodiment can display more vividly and intuitively to the user whether the recognized volume value is within the preset volume value range.

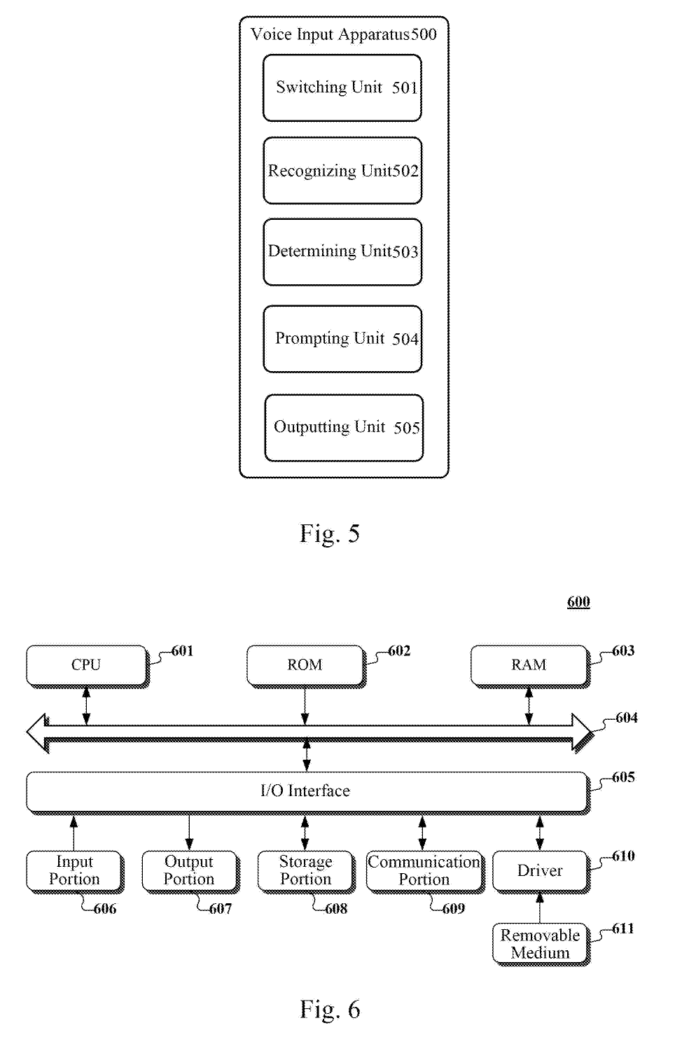

With further reference to FIG. 5, as an implementation to the method illustrated in the above figures, the present disclosure provides an embodiment of a voice input apparatus. The apparatus embodiment corresponds to the method embodiment shown in FIG. 2, and the apparatus may be specifically applied to various electronic devices.

As shown in FIG. 5, the voice input apparatus 500 of the present embodiment includes: a switching unit 501, a recognizing unit 502, a determining unit 503, a prompting unit 504 and an outputting unit 505. Here, the switching unit 501 is configured to switch, in response to detecting an instruction to start a voice input mode, a current input mode of an input method application to the voice input mode. The recognizing unit 502 is configured to recognize a volume value of a voice input by a user in the voice input mode. The determining unit 503 is configured to determine whether the recognized volume value is within a preset volume value range. The prompting unit 504 is configured to present to the user prompt information for prompting the user to control the volume value of the currently input voice, if the recognized volume value is not within the preset volume value range. The outputting unit 505 is configured to output, in response to receiving an instruction to end the voice input, the voice input by the user in the voice input mode in a preset mode.

In the present embodiment, the specific processing and the advantageous effects thereof of the switching unit 501, the recognizing unit 502, the determining unit 503, the prompting unit 504 and the outputting unit 505 in the voice input apparatus 500 may refer to the related descriptions to the implementations of step 201, step 202, step 203, step 204 and step 205 in the corresponding embodiment in FIG. 2, detailed description thereof will be omitted.

In some alternative implementations of the present embodiment, the determining unit 503 includes: a generating subunit (not shown in the figure), configured to generate a waveform matching the recognized volume value based on the recognized volume value, and display the waveform in an input area of the input method application; and a determining subunit (not shown in the figure), configured to determine whether an amplitude of the waveform exceeds a target area, wherein the target area is an area pre-partitioned in the input area matching the preset volume value range.

In some alternative implementations of the present embodiment, the prompting unit 504 is further configured to: present to the user prompt information for prompting the user to reduce the volume value of the input voice, if a crest of the waveform crosses an upper limit indication line of the target area, wherein the upper limit indication line corresponds to a maximum value of the preset volume value range.

In some alternative implementations of the present embodiment, the prompting unit 504 is further configured to: present to the user prompt information for prompting the user to increase the volume value of the input voice, if a trough of the waveform crosses a lower limit indication line of the target area, wherein the lower limit indication line corresponds to a minimum value of the preset volume value range.

In some alternative implementations of the present embodiment, the outputting unit 505 is further configured to: output a text matching the voice input by the user converted from the voice input by the user in the voice input mode.

In some alternative implementations of the present embodiment, the outputting unit 505 is further configured to: output the voice input by the user in the voice input mode, after amplifying the volume of the voice.

In some alternative implementations of the present embodiment, a prompting mode of the prompt includes at least one of the following: a vibration prompt, a ringtone prompt, a voice prompt and a text prompt.

With reference to FIG. 6, a schematic structural diagram of a computer system 600 adapted to implement a terminal device of the embodiments of the present disclosure is illustrated. The terminal device shown in FIG. 6 is merely an example and should not impose any restriction on the functions and the scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 comprising a cathode ray tube (CRT), a liquid crystal display device (LCD), a speaker etc.; a storage portion 608 including a hard disk and the like; and a communication portion 609 comprising a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to an embodiment of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 609, and/or may be installed from the removable media 611. The computer program, when executed by the central processing unit (CPU) 601, implements the above mentioned functionalities as defined by the methods of the present application.

It needs to be noted that the computer readable medium in the present disclosure may be computer readable signal medium or computer readable storage medium or a combination thereof. An example of the computer readable storage medium may include but not limited to: systems, apparatus or elements of electric, magnet, optical, electromagnet, infrared ray, or semiconductor or a combination thereof. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or a combination thereof. In the present disclosure, the computer readable storage medium may be any physical medium containing or storing programs which can be used by a command execution system, apparatus or element or the incorporation thereof. In the present disclosure, the computer readable signal medium may include data signal in the base band or propagating as parts of a carrier in which computer readable program codes are carried. The propagated signal may take various forms, include but is not limited to: an electromagnetic signal, an optical signal or a combination thereof. The signal medium that can be read by computer may be any computer readable medium except for the computer readable storage medium. The computer readable medium is capable of transmitting, propagating or transferring programs for used by or used in combination with a command execution system, apparatus or element. The program codes contained on the computer readable medium may be transmitted with any suitable medium including but is not limited to: a wireless medium, a wired medium, an optical cable medium, a RF medium and the like, or any combination thereof.

The flowcharts and block diagrams in the figures illustrate architectures, functions and operations that may be implemented according to the system, the method and the computer program product of the various embodiments of the present invention. In this regard, each block in the flowcharts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

The units or modules involved in the embodiments of the present application may be implemented by way of software or hardware. The described units or modules may also be provided in a processor, for example, described as: a processor, comprising a switching unit, a recognizing unit, a determining unit, a prompting unit and an outputting unit, where the names of these units or modules are not considered as a limitation to the units or modules. For example, the switching unit may also be described as “a unit for switching, in response to detecting an instruction to start a voice input mode, a current input mode of an input method application to the voice input mode.”

In another aspect, the present application further provides a non-volatile computer storage medium. The non-volatile computer storage medium may be the non-volatile computer storage medium included in the apparatus in the above embodiments, or a stand-alone non-volatile computer storage medium which has not been assembled into the apparatus. The non-volatile computer storage medium stores one or more programs. The one or more programs, when executed by a device, cause the device to: switching, in response to detecting an instruction to start a voice input mode, a current input mode of an input method application to the voice input mode; recognizing a volume value of a voice input by a user in the voice input mode; determining whether the recognized volume value is within a preset volume value range; presenting to the user prompt information for prompting the user to control the volume value of the currently input voice, if the recognized volume value is not within the preset volume value range; and outputting, in response to receiving an instruction to end the voice input, the voice input by the user in the voice input mode in a preset mode.

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

What is claimed is:

1. A voice input method, comprising:
switching, in response to detecting an instruction to start a voice input mode, a current input mode of an input method application to the voice input mode;
recognizing a volume value of a voice input by a user in the voice input mode;
determining whether the recognized volume value is within a preset volume value range;
presenting to the user prompt information for prompting the user to control the volume value of the currently input voice, if the recognized volume value is not within the preset volume value range; and
outputting, in response to receiving an instruction to end the voice input, the voice input by the user in the voice input mode in a preset mode.

2. The method according to claim 1, wherein the determining whether the recognized volume value is within a preset volume value range comprises:
generating a waveform matching the recognized volume value based on the recognized volume value, and displaying the waveform in an input area of the input method application; and
determining whether an amplitude of the waveform exceeds a target area, wherein the target area is an area pre-partitioned in the input area matching the preset volume value range.

3. The method according to claim 2, wherein the presenting to the user prompt information for prompting the user to control the volume value of the currently input voice, if the recognized volume value is not within the preset volume value range comprises:
presenting to the user prompt information for prompting the user to reduce the volume value of the input voice, if a crest of the waveform crosses an upper limit indication line of the target area, wherein the upper limit indication line corresponds to a maximum value of the preset volume value range.

4. The method according to claim 2, wherein the presenting to the user prompt information for prompting the user to control the volume value of the currently input voice, if the recognized volume value is not within the preset volume value range comprises:
presenting to the user prompt information for prompting the user to increase the volume value of the input voice, if a trough of the waveform crosses a lower limit indication line of the target area, wherein the lower limit indication line corresponds to a minimum value of the preset volume value range.

5. The method according to claim 3, wherein the presenting to the user prompt information for prompting the user to control the volume value of the currently input voice, if the recognized volume value is not within the preset volume value range comprises:
presenting to the user prompt information for prompting the user to increase the volume value of the input voice, if a trough of the waveform crosses a lower limit indication line of the target area, wherein the lower limit indication line corresponds to a minimum value of the preset volume value range.

6. The method according to claim 1, wherein the outputting the voice input by the user in the voice input mode in a preset mode comprises:
outputting a text matching the voice input by the user, the text being converted from the voice input by the user in the voice input mode.

7. The method according to claim 1, wherein the outputting the voice input by the user in the voice input mode in a preset mode comprises:
amplifying the voice input by the user in the voice input mode and outputting the amplified voice.

8. The method according to claim 1, wherein a prompting mode of the prompt information includes at least one of the following:
a vibration prompt, a ringtone prompt, a voice prompt and a text prompt.

9. A voice input apparatus, comprising:
at least one processor; and
a memory storing instructions, which when executed by the at least one processor, cause the at least one processor to perform operations, the operations comprising:
switching, in response to detecting an instruction to start a voice input mode, a current input mode of an input method application to the voice input mode;
recognizing a volume value of a voice input by a user in the voice input mode;
determining whether the recognized volume value is within a preset volume value range;
presenting to the user prompt information for prompting the user to control the volume value of the currently input voice, if the recognized volume value is not within the preset volume value range; and
outputting, in response to receiving an instruction to end the voice input, the voice input by the user in the voice input mode in a preset mode.

10. The apparatus according to claim 9, wherein the determining whether the recognized volume value is within a preset volume value range comprises:
generating a waveform matching the recognized volume value based on the recognized volume value, and display the waveform in an input area of the input method application; and
determining whether an amplitude of the waveform exceeds a target area, wherein the target area is an area pre-partitioned in the input area matching the preset volume value range.

11. The apparatus according to claim 10, wherein the presenting to the user prompt information for prompting the user to control the volume value of the currently input voice, if the recognized volume value is not within the preset volume value range comprises:
presenting to the user prompt information for prompting the user to reduce the volume value of the input voice, if a crest of the waveform crosses an upper limit indication line of the target area, wherein the upper limit indication line corresponds to a maximum value of the preset volume value range.

12. The apparatus according to claim 10, wherein the presenting to the user prompt information for prompting the user to control the volume value of the currently input voice, if the recognized volume value is not within the preset volume value range comprises:
presenting to the user prompt information for prompting the user to increase the volume value of the input voice, if a trough of the waveform crosses a lower limit indication line of the target area, wherein the lower limit indication line corresponds to a minimum value of the preset volume value range.

13. The apparatus according to claim 11, wherein the presenting to the user prompt information for prompting the user to control the volume value of the currently input voice, if the recognized volume value is not within the preset volume value range comprises:
presenting to the user prompt information for prompting the user to increase the volume value of the input voice, if a trough of the waveform crosses a lower limit indication line of the target area, wherein the lower limit indication line corresponds to a minimum value of the preset volume value range.

14. A computer readable storage medium storing a computer program, when the computer program executed by a processor, cause the one or more processors to perform operations, the operations comprising:
switching, in response to detecting an instruction to start a voice input mode, a current input mode of an input method application to the voice input mode;
recognizing a volume value of a voice input by a user in the voice input mode;
determining whether the recognized volume value is within a preset volume value range;
presenting to the user prompt information for prompting the user to control the volume value of the currently input voice, if the recognized volume value is not within the preset volume value range; and
outputting, in response to receiving an instruction to end the voice input, the voice input by the user in the voice input mode in a preset mode.
